(19) United States
(12) Patent Application Publication
(10) Pub. No.: US 2010/0055523 A1
(43) Pub. Date: Mar. 4, 2010

(54) FUEL CELL SYSTEM

(75) Inventors: Jumpei Ogawa, Saitama (JP); Chihiro Wake, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HONDA MOTOR CO., LTD., Tokyo (JP)

(21) Appl. No.: 12/547,274

(22) Filed: Aug. 25, 2009

(30) Foreign Application Priority Data
Aug. 26, 2008 (JP) 2008-217017

(51) Int. Cl. H01M 8/04

(52) U.S. Cl. 429/25; 429/22

(57) ABSTRACT

A fuel cell system draining water in a air-and-water separator includes: a fuel cell stack; a hydrogen-circulating line; an air-and-water separator; a drain unit including a drain valve for draining the water stored in the air-and-water separator; a drain-control unit for controlling the drain unit; a determining unit for determining whether or not the drain-control unit decides that the drain unit should be opened; a frozen-state-presuming unit presuming whether or not the drain unit is frozen; and a thawing-state-determining unit determining whether or not the drain unit is thawed, wherein the drain-control unit controls the drain unit so that a greater amount of the water is drained than a water drained in an ordinary state process which presumes that the drain unit is not frozen, after the frozen-state-presuming unit presumes that the drain unit is frozen and when the thawing-state-determining unit determines mat the drain unit is thawed.

### CROSS-REFERENCE TO RELATED APPLICATION

This application claims the foreign priority benefit under Title 35, United States Code, §119(a)-(d), of Japanese Patent Application No. 2008-217017, filed on Aug. 26, 2008, in the Japan Patent Office, the disclosure of which is herein incorporated by reference in its entirety.

### BACKGROUND OF THE INVENTION

1. Field of the Invention

The present invention relates to a fuel cell system.

2. Description of the Related Art

In recent years, fuel cell systems provided with fuel cells including a Polymer Electrolyte Fuel Cell (PEFC), which generates power using hydrogen (fuel gas, reaction gas) supplied to an anode and air (oxidizer gas, reaction gas) including oxygen supplied to a cathode, are gaining attention and are mounted on, for example, a fuel cell vehicle.

When the fuel cell of this kind generates electricity, since water, moisture, or vapor (hereinafter simply called water) is produced at the cathode, and part of the water permeates to the anode, anode-off-gas discharged from the anode of the fuel cell is humid. In addition, the anode-off-gas includes hydrogen which has not been reacted when the electricity was generated.

In a technology proposed for increasing the effective use of the hydrogen, water vapor is separated from the anode-off-gas by an air-and-water separator, and after that, hydrogen is returned and supplied again to upstream of the fuel cell for circulating the hydrogen (see Japanese Patent Laid-open Publication No. 2007-265676).

However, if the fuel cell system provided with the fuel cell and the air-and-water separator is exposed to a low-temperature condition (for example, under 0° C.) while the fuel cell system is stopped, the air-and-water separator, a drain valve for draining the separated water stored in the air-and-water separator, and pipings (drain unit) which connect these components are frozen, and the water in the air-and-water separator cannot be drained until the fuel cell system is started up anew and the drain valve or the likes is thawed; therefore, the amount of water in the air-and-water separator increases.

If the amount of the water has increased in the air-and-water separator, the water increased in the air-and-water separator cannot be drained sufficiently by merely opening the drain valve to an ordinary degree after thawing the drain valve or the likes; therefore, there is a concern that the water together with the hydrogen supplied to the fuel cell will lower the power-generating capability.

It is an object of the present invention to provide a fuel cell system for draining water in the air-and-water separator desirably.

### BRIEF SUMMARY OF THE INVENTION

The present invention as a means for achieving the aforementioned object is a fuel cell system which comprises: a fuel cell for generating electricity, the fuel cell having a fuel gas flow path and an oxidizer-gas flow path, the fuel gas being supplied to the fuel gas flow path, oxidizer gas being supplied to the oxidizer-gas flow path; a fuel-gas-circulating line for circulating the fuel gas by returning fuel-off-gas discharged from the fuel gas flow path to a fuel gas flow path upstream relative to the fuel cell; an air-and-water separator provided in the fuel-gas-circulating line, the air-and-water separator separating water from the fuel-off-gas and storing the separated water; a drain unit for draining the separated water stored in the air-and-water separator, the drain unit including a drain valve through which the water is drained; a drain-control unit for controlling the drain unit; a determining unit for determining whether or not the drain-control unit decides that the drain unit should be opened; a frozen-state-presuming unit for presuming whether or not the drain unit is frozen if the determining unit determines that drain-control unit decides that the drain unit should be opened; and a thawing-state-determining unit for determining whether or not the drain unit is thawed if the frozen-state-presuming unit presumes that the drain unit is frozen, wherein the drain-control unit controls the drain unit in such a manner that a greater amount of the water is drained than a water drained in an ordinary state process which presumes that the drain unit is not frozen, if the thawing-state-determining unit determines that the drain unit is thawed after the frozen-state-presuming unit presumes that the drain unit is frozen.

According to the aforementioned fuel cell system, the drain-control unit controls the drain unit in such a manner that a greater amount of the water is drained than a water drained in an ordinary state process which presumes that the drain unit is not frozen, if the thawing-state-determining unit determines that the drain unit is thawed after the frozen-state-presuming unit presumes that the drain unit is frozen. More specifically, at least one of the following can be adopted: (1) the amount of water drained per one time opening of the drain valve 26 is increased; and (2) the interval (for closing the drain valve 26) between opening states of the drain valve 26 is shortened.

Accordingly, the water can be drained from the air-and-water separator appropriately since the amount of the water drained from the drain unit increases even if a greater amount of water stored in the air-and-water separator increases when the fuel cell stack generates electricity between a time of currently starting up the system and a time prior to thawing the drain unit. Therefore, the water in the air-and-water separator together with the circulated fuel gas are hardly supplied to the fuel cell; thus, the fuel cell can be prevented from lowering the power-generating capability caused by the water.

Also, the present invention is the fuel cell system which further comprises a gas-pressure control apparatus controlling pressure of the fuel-off-gas flowing through the air-and-water separator in such a manner that the pressure of the gas flowing through the air-and-water separator is higher than pressure of the gas in the ordinary state process if the thawing-state-determining unit determines that the drain unit is thawed after the frozen-state-presuming unit presumes that the drain unit is frozen.

According to the fuel cell system, the fuel cell system can increase a flow amount of the water drained from the air-and-water separator based on the increased pressure since a gas-pressure control apparatus controls pressure of gas flowing through the air-and-water separator in such a manner that the pressure of the gas flowing through the air-and-water separator is higher than pressure of the gas in the ordinary state process if the thawing-state-determining unit determines that the drain unit is thawed after the frozen-state-presuming unit presumes that the drain unit is frozen. Accordingly, the water in the air-and-water separator can be drained rapidly.

Also, the present invention is the fuel cell system in which the gas-pressure control apparatus controls in such a manner that the greater the amount of water stored in the air-and-water separator is, the higher the pressure of the fuel-off-gas flowing through the air-and-water separator is.

According to the aforementioned fuel cell system, the stored water can be drained more suitably since the greater the amount of water stored in the air-and-water separator is, the higher the pressure of the fuel-off-gas flowing through the air-and-water separator is.

Also, the present invention is the fuel cell system, wherein the drain-control unit extends time for opening the drain valve longer than time for opening the drain valve in the ordinary state process if the thawing-state-determining unit determines that the drain unit is thawed after the frozen-state-presuming unit presumes that the drain unit is frozen.

Accordingly, the aforementioned fuel cell system can increase the amount of the water drained from the air-and-water separator since the drain-control unit extends time for opening the drain valve longer than time for opening the drain valve in the ordinary state process if the thawing-state-determining unit determines that the drain unit is thawed.

Also, the present invention is the fuel cell system, wherein the drain-control unit controls the drain valve in such a manner that the greater the amount of water stored in the air-and-water separator is, the longer a time for opening the drain valve is.

Accordingly, the aforementioned fuel cell system can drain the stored water more suitably since the drain-control unit extends the time for opening the drain valve longer if a greater amount of water is stored in the air-and-water separator.

Also, the present invention is the fuel cell system, wherein the drain-control unit does not open the drain valve if the frozen-state-presuming unit presumes that the drain unit is frozen and when the thawing-state-determining unit determines that the drain unit is not thawed.

According to the aforementioned fuel cell system, the drain valve will not be controlled to open while the drain unit including the drain valve is frozen since the drain-control unit does not open the drain valve if the frozen-state-presuming unit presumes that the drain unit is frozen and when the thawing-state-determining unit determines that the drain unit is not thawed. That is, the drain valve in a frozen state will not be controlled to open; therefore, the drain valve will be free from defect.

Also, the present invention is the fuel cell system, wherein the drain-control unit controls the drain unit in the ordinary state process if a predetermined amount of water sent from the air-and-water separator is drained by the drain unit after the frozen-state-presuming unit presumes that the drain unit is frozen and the thawing-state-determining unit determines that the drain unit is thawed.

According to the aforementioned fuel cell system, the drain-control unit controls the drain unit in the ordinary state process if the predetermined amount of water sent from the air-and-water separator is drained by the drain unit.

Accordingly, the energy (electricity consumed by the drain valve in the embodiment explained later) for activating the drain unit can be reduced, and hydrogen is prevented from being discharged when the drain valve is in an excessive open state.

### EFFECT OF THE PRESENT INVENTION

According to the present invention, a fuel cell system is provided for draining water in the air-and-water separator desirably

### BRIEF DESCRIPTION OF THE DRAWINGS

FIG. 1 shows the configuration of a fuel cell system according to a present embodiment.

FIG. 2 is a map showing relationship between system temperature when IG is turned on and valve-opening time (anode pressure) for performing post-thawing water-draining.

FIG. 3 is a flowchart showing operations of the fuel cell system according to the present embodiment when the fuel cell system is stopped.

FIG. 4 is a flowchart showing operations of the fuel cell system according to the present embodiment when the fuel cell system is started up.

### DETAILED DESCRIPTION OF THE INVENTION

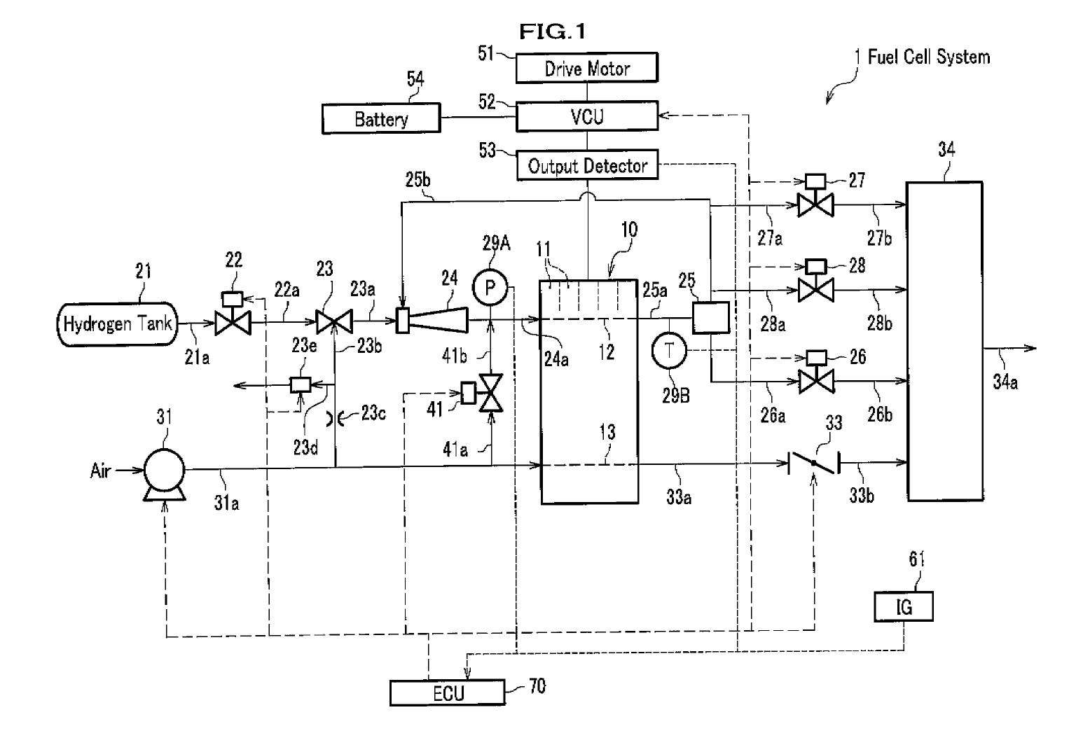

An embodiment of the present invention will be explained with reference to FIGS. 1 to 4.

### <<Configuration of Fuel Cell System>>

A fuel cell system 1 shown in FIG. 1 according to the present embodiment is mounted on a fuel-cell vehicle (moving object) not shown in the drawings. The fuel cell system 1 includes a fuel cell stack 10; an anode system supplying hydrogen (fuel gas, reaction gas) to or discharging hydrogen (fuel gas, reaction gas) from an anode of the fuel cell stack 10; a cathode system supplying air (oxidizer gas, reaction gas) including oxygen to or discharging air (oxidizer gas, reaction gas) including oxygen from a cathode of the fuel cell stack 10; a scavenging-gas-introducing system introducing the scavenging-gas into an anode system which is to be scavenged; an electricity-consuming system consuming the electricity generated by the fuel cell stack 10; an IG61; and an electronic control unit (ECU) 70 for electronically controlling these components.

### <Fuel Cell Stack>

The fuel cell stack 10 is constituted by a plurality of (for example, 200 to 400 cells) polymer electrolyte single cells 11 which are stacked and connected electrically in series. Each single cell 11 is provided with a Membrane Electrode Assembly (MEA); and two conductive separators including an anode separator and a cathode separator between which the MEA is disposed.

The MEA is provided with an electrolyte membrane (solid polymer electrolyte membrane) made of a membrane for exchanging a univalent positive ion (for example, perfluorosulfonate type); and an anode and a cathode between which the electrolyte membrane is disposed. The anode and the cathode are mainly made of conductive porous members such as a carbon paper, and include a catalyst (Pt, Ru or the likes) on which electrochemical reaction occurs between the anode and the cathode.

Formed in the anode separator are through-holes (called inner manifolds), extending in the stacking direction of the single cells 11, for supplying hydrogen to or discharging hydrogen from the anode of each MEA; and grooves extending in the surface direction of the single cells 11. These through-holes and the grooves function as an anode flow path 12 (fuel gas flow path).

Formed in the cathode separator are through-holes (called inner manifolds), extending in the direction of the layered single cells 11, for supplying air to or discharging air from the cathode of each MEA; and grooves extending in the surface direction of the single cells 11. These through-holes and the grooves function as a cathode flow path 13 (oxidizer-gas flow path).

When hydrogen is supplied to each anode through the anode flow path 12, an oxidation reaction indicated by a formula (1) below occurs, and while air is supplied to each cathode through the cathode flow path 13, a reaction indicated by a formula (2) below occurs. Due to an electric potential difference between the reactions (1) and (2), a voltage is generated in each single cell 11. Subsequently, when electric current is extracted by connecting the fuel cell stack 10 to an external circuit including a driving motor 51 electrically, the fuel cell stack 10 is configured to generate electricity.

2H₂→4H⁺+4e⁻ (1)

O₂+4H⁺+4e⁻→2H₂O (2)

### <Anode System>

The anode system includes a hydrogen tank 21 (fuel gas source) containing highly pressurized hydrogen sealed therein; a normally shut-off valve 22; a decompression valve 23 (regulator); an ejector 24; an air-and-water separator 25; a drain valve 26; a purge valve 27; a scavenging-gas-discharging valve 28; a pressure sensor 29A; and a temperature sensor 29B.

The hydrogen tank 21 containing highly pressurized hydrogen sealed therein is connected to the inlet of the anode flow path 12 through a piping 21a, a shut-off valve 22, a piping 22a, the decompression valve 23, a piping 23a, the ejector 24, and a piping 24a. The hydrogen in the hydrogen tank 21 is supplied to the anode flow path 12 through the piping 21a or the likes when the ECU 70 opens the shut-off valve 22.

The air pressure supplied from a compressor 31 to the cathode flow path 13 and indicating a signal pressure (pilot pressure) is put into the decompression valve 23 through a piping 23b having an orifice 23c provided therein. In addition, the decompression valve 23 controls the pressure of hydrogen based on the pressure of air put thereinto.

The piping 23b is connected to an injector 23e through a piping 23d. When the injector 23e opens according to an instruction for opening (pulse signal (PWM signal)) supplied by the ECU 70, air is ejected to the exterior thereof, and the pressure in the piping 23d and the piping 23b indicating the pilot pressure put into the decompression valve 23 decreases.

That is, the ECU 70 controlling (PWM control) the injector 23e changes the pilot pressure put into the decompression valve 23, and accordingly, the secondary pressure of the decompression valve 23 indicating the pressure of the anode-off-gas passing through the air-and-water separator 25 (pressure of hydrogen in the anode flow path 12) is controlled.

Therefore, in the present embodiment, a gas-pressure control apparatus controlling the pressure of the gas flowing through the air-and-water separator 25 includes the decompression valve 23, the injector 23e, and the ECU 70. However, the gas-pressure control apparatus is not limited to this configuration and may use, for example, a butterfly valve having variably controllable opening degree.

In the present embodiment, the pressure sensor 29A is attached to the piping 24a provided upstream from the anode flow path 12 so that the pressure of the gas in the anode flow path 12 (air-and-water separator 25) can be detected. The pressure sensor 29A outputs the detected pressure to the ECU 70.

However, the pressure sensor 29A is not limited to be provided in this position and may be attached, for example, to a piping 25a provided downstream relative to the anode flow path 12.

An outlet of the anode flow path 12 is connected to a suction port of the ejector 24 through the piping 25a, the air-and-water separator 25, and a piping 25b. The anode-off-gas (fuel-off gas) including non-reacted hydrogen discharged from the anode flow path 12 (anode) flows through the piping 25a and is returned to the ejector 24 provided upstream relative to the fuel cell stack 10 for circulating the hydrogen.

That is, the piping 25a and the piping 25b form a hydrogen-circulating line (fuel-gas-circulating line), and the air-and-water separator 25 is provided in the hydrogen-circulating line.

The air-and-water separator 25 separates water from the anode-off-gas that has been introduced into the air-and-water separator 25, and stores the separated water thereinside temporarily. For example, a method of separating air and water in the air-and-water separator 25 may increase the flow-path's cross-sectional area for the anode-off-gas in the air-and-water separator 25 significantly for reducing the flow speed thereof so that water having a more significant specific gravity than that of the hydrogen is separated. Alternatively, a method may be adoptable in which the anode-off-gas is refrigerated by using a coolant pipe flowing a low temperature refrigerant therethrough to separate the water vapor.

In addition, the anode-off-gas having been separated from the water is returned to the ejector 24 through the piping 25b; and the separated (collected) water is stored in the bottom section of the air-and-water separator 25 temporarily.

The bottom section of the air-and-water separator 25 is connected to a diluting unit 34, which will be explained later, through a piping 26a, the normally shut-off drain valve 26, and a piping 26b. The drain valve 26 drains the water stored in the air-and-water separator 25, and when the drain valve 26 is opened by the ECU 70 (drain control unit), the water (reservoir water) in the air-and-water separator 25 is drained to the diluting unit 34 through the piping 26a, the drain valve 26, and the piping 26b.

Therefore, in the present embodiment, the drain-function unit (drain unit) draining the water stored in the air-and-water separator 25 includes the bottom section (tank section) of the air-and-water separator 25, the piping 26a, the drain valve 26, and the piping 26b.

The piping 25b is connected to the diluting unit 34 through a piping 27a, the normally shut-off purge valve 27, and a piping 27b. The purge valve 27 is opened by the ECU 70 for discharging (purging) impurities (water vapor, nitrogen or the like) included in the anode-off-gas (hydrogen) circulating in the piping 25a and the piping 25b while the fuel cell stack 10 generates electricity.

It should be noted that the ECU 70 is set to open the purge valve 27 periodically by using a timer, and is additionally set to open the purge valve 27 when the ECU 70 decides that impurities must be discharged when, for example, the voltage (cell voltage) of the single cell 11 is at a predetermined cell voltage or lower. The cell voltage is detected by, for example, a voltage sensor (cell voltage monitor) for detecting the voltage of the single cell 11.

In addition, the piping 25b provided upstream relative to the correcting position of the piping 27a is connected to the diluting unit 34 through a piping 28a, the normally shut-off scavenging-gas-discharging valve 28, and a piping 28b. The scavenging-gas-discharging valve 28 is set to be opened together with a scavenging-gas-introducing valve 41, which will be explained later, by the ECU 70 when scavenging the fuel cell stack 10, more specifically, when scavenging the anode flow path 12 while the compressor 31 is operated.

The time of scavenging the fuel cell stack 10 means a time at which the system temperature T11 detected by the temperature sensor 29B is lower than the predetermined temperature while, for example, the fuel cell system is kept stopped and at which the inside of the fuel cell stack 10 may be frozen later.

When the ECU 70 decides that the inside of the fuel cell stack 10 is frozen, the ECU 70 starts the compressor 31, opens the scavenging-gas-introducing valve 41 and the scavenging-gas-discharging valve 28, sends the scavenging-gas forcibly from the compressor 31 into the anode flow path 12 and the cathode flow path 13, removes the water from the anode flow path 12 or the like, and scavenges the fuel cell stack 10.

The temperature sensor 29B attached to the piping 25a detects the temperature in the piping 25a as the system temperature T11. In addition, the temperature sensor 29B outputs the detected system temperature T11 to the ECU 70.

However, the temperature sensor 29B is not necessarily attached to this position and may be provided to a piping 33a or other pipings (not shown in the drawings) through which refrigerant discharged from the fuel cell stack 10 flows.

### <Cathode System>

The cathode system is provided with the compressor 31, a back-pressure-regulating valve 33, and the diluting unit 34.

The compressor 31 connected to an inlet of the cathode flow path 13 through a piping 31a brings in air including oxygen and supplies the air to the cathode flow path 13 when the compressor 31 is operated in accordance with an instruction sent from the ECU 70. In addition, the compressor 31 is started for scavenging the fuel cell stack 10 and is operable as a scavenging-gas-supply unit for supplying scavenging-gas.

It should be noted that the compressor 31 operates on electricity supplied from the fuel cell stack 10 or a battery 54 to be charged by the fuel cell stack 10. In addition, the shut-off valve 22 of the anode system, the drain valve 26, the purge valve 27 and the scavenging-gas-discharging valve 28, the back-pressure-regulating valve 33 of the cathode system, and the scavenging-gas-introducing valve 41, which will be explained later, are operated using electricity supplied by the battery 54, while the fuel cell stack 10 is not in operation.

A humidifier (not shown in the drawings) is attached to the piping 31a for humidifying air sent to the cathode flow path 13. The humidifier provided with hollow fiber membranes capable of exchanging water exchanges water between air sent to the cathode flow path 13 and humid cathode-off-gas by means of the hollow fiber membranes. It should be noted that a bypass pipe (not shown in the drawings) passing by the humidifier is provided so that scavenging-gas sent from the compressor 31 passes by the humidifier when scavenging the fuel cell stack 10.

An outlet of the cathode flow path 13 is connected to the diluting unit 34 through the piping 33b, the back-pressure-regulating valve 33, and a piping 33b. The humid cathode-off-gas discharged from the cathode flow path 13 (cathode) is discharged to the diluting unit 34 through the piping 33a or the like.

The back-pressure-regulating valve 33 is a normally-open valve such as a butterfly valve or the like, and its opening degree is controlled by the ECU 70.

The diluting unit 34 using the cathode-off-gas and having a space for dilution thereinside dilutes the hydrogen included in the anode-off-gas sent from the piping 27b. The diluted gas is discharged to the exterior of a vehicle through a piping 34a.

### <Scavenging-Gas-Introducing System>

The scavenging-gas-introducing system introduces the scavenging gas discharged from the compressor 31 into the anode system when scavenging the anode flow path 12, and is provided with the normally shut-off scavenging-gas-introducing valve 41 which is opened by the ECU 70 at time of scavenging. In addition, an upstream side of the scavenging-gas-introducing valve 41 is connected to the piping 31a through a piping 41a, and a downstream side of the scavenging-gas-introducing valve 41 is connected to the piping 22a through a piping 41b.

### <Electricity-Consuming System>

An electricity-consuming system is provided with the driving motor 51, a voltage control unit (VCU) 52, an output detector 53, and the battery 54. The driving motor 51 is connected to an output terminal (not shown in the drawings) of the fuel cell stack 10 through the VCU 52 and the output detector 53. The battery 54 is connected to the VCU 52.

The driving motor 51 is an external load and a power source for driving the fuel-cell vehicle.

The VCU 52 is equipment for controlling (regulating) the electricity (output electric current, output electric voltage) generated by the fuel cell stack 10 and for controlling electricity charged into or discharged from the battery 54 in accordance with an instruction electric current sent from the ECU 70. The VCU 52 is provided with an electronic circuit such as the DC/DC chopper, the DC/DC converter, and the like. That is, the fuel cell stack 10 generates electricity when the VCU 52 is controlled appropriately and electricity is taken out from the fuel cell stack 10.

The output detector 53 detects currently-obtained output electric current and output electric voltage of the fuel cell stack 10 and is provided with an electric current sensor and an electric voltage sensor that are arranged at appropriate locations. In addition, the output detector 53 outputs the currently-obtained output electric current and output electric voltage to the ECU 70.

The battery 54 provided with, for example, a plurality of lithium-ion secondary batteries charges excess electricity of the fuel cell stack 10 or regenerated electricity of the driving motor 51 thereinside, or assists shortage of electricity of the fuel cell stack 10. In addition, the battery 54 is operable as a power source for the compressor 31 or the like while the fuel cell stack 10 is stopping generation of electricity. It should be noted that a power source line connecting the battery 54 to the compressor 31 or the like is omitted.

### <IG>

The IG61 is a start-up switch for the fuel-cell vehicle and the fuel cell system 1 and is provided in the vicinity of a driver's seat. The IG61 outputs its ON-signal (signal for starting up the system) and its OFF-signal (signal for stopping the system) to the ECU 70.

### <ECU>

The ECU 70 is a control device for electronically controlling the fuel cell system 1 and includes a CPU, a ROM, a RAM, various interfaces, electronic circuits, and the like. The ECU 70 is configured to control various devices appropriately in accordance with programs stored thereinside.

### <ECU: Function for Determining Valve-Opening Request>

The ECU 70 (a unit for deciding whether or not drain valve should be opened) is provided with a function of deciding whether or not the drain valve 26 should be opened.

The ECU 70 decides, for example, at a reference interval predetermined according to the size of air-and-water separator 25 (storable capacity for water), the amount of water drained from the fuel cell stack 10 while electricity is generated, that the drain valve 26 should be opened in any cases of an ordinary state process which presumes that the drain-function unit is not frozen; a frozen state which presumes that the drain-function unit is frozen; and a thawing state in which the drain-function unit is thawed after presuming the frozen state.

Alternatively, the ECU 70 may use a water level sensor provided in the air-and-water separator 25 for detecting water level of reservoir water and decide that the drain valve 26 should be opened if the currently-detected water level exceeds a valve-opening water level which indicates that the drain valve 26 should be opened.

### <ECU: Function for Presuming Frozen State>

The ECU 70 (frozen-state-presuming unit) is provided with a function of presuming whether or not the drain-function unit is frozen when the system is started up. It should be noted here that the ECU 70 presumes that the drain-function unit is frozen when the system is started up if the dram-function unit has experienced a frozen state between a previous suspension and a currently-started-up condition of the system.

More specifically, the ECU 70 is set to presume that the dram-function unit has experienced a frozen state and is frozen at present if: (1) the system temperature T11 during suspension of the system is lower than freezing temperature T2 (for example, 0° C.) which presumes that the drain-function unit is frozen; (2) the fuel cell stack 10 is scavenged during suspension of the system; (3) the system temperature T11 prior to starting generation of electricity when the system is currently started up is lower than freezing temperature T3 (for example, 0° C.); or (4) the system is currently started up in a low-temperature-startup process which will be explained later.

### <ECU: Function for Presuming Thawing State>

The ECU 70 (thawing-state-determining unit) has a function of deciding whether or not the drain-function unit is thawed by the self-heating of the fuel cell stack 10 generating electricity or by open air if the ECU 70 has presumed that the drain-function unit is frozen.

More specifically, the ECU 70 is set to decide that the drain-function unit is thawed in any case of, for example: (1) the system temperature T11 (temperature of the anode-off-gas) detected by the temperature sensor 29B is at thawing temperature T4 (for example, 20° C.) or higher in which the ECU 70 presumes that the drain-function unit is thawed; (2) the total electric-power-generating time of the currently-started-up fuel cell stack 10 exceeds thawing time (for example, three minutes) which the ECU 70 presumes that the drain-function unit is thawed; (3) the accumulated heat generated by the fuel cell stack 10 exceeds accumulated heat at which the ECU 70 presumes that the drain-function unit is thawed; or (4) the accumulated amount of electricity generated by the fuel cell stack 10 and calculated based on the output electric voltage and the output electric current exceeds accumulated amount of electricity which ECU 70 presumes that the drain-function unit is thawed.

### <ECU: Drain-Controlling Function>

The ECU 70 (drain-control unit) is provided with a drain-control function of controlling water-draining of the water from the air-and-water separator 25 by appropriately opening the normally-closed drain valve 26 constituting the drain-function unit. However, the ECU 70 controls the drain valve 26 so that hydrogen which should be circulated through the drain valve 26 is not discharged and so that not all the water in the air-and-water separator 25 should be drained.

More specifically, the ECU 70 is set to perform ordinary water-draining control in the ordinary state process in which the ECU 70 presumes that drain-function unit is not frozen. Performing an ordinary water-draining control means that drain valve 26 is opened for an ordinary opening time in response to the determination, made by the ECU 70, that the drain valve 26 should be opened.

On the other hand, the ECU 70 is set to not open the drain valve 26 if the ECU 70 presumes that the drain-function unit has been frozen and decides that the drain-function unit has not been thawed yet.

The ECU 70 is set to perform post-thawing water-draining if the ECU 70 decides that the drain-function unit is thawed after presuming the frozen state. Performing the post-thawing water-draining means that the ECU 70 controls so that a greater amount of water should be drained from the air-and-water separator 25 than that of the ordinary state process in which the drain-function unit is not frozen.

More specifically, at least one of the following can be adopted: (1) an amount of the water to be drained in one opening of the drain valve 26 is increased; and (2) the interval (time for the drain valve 26 being closed) for opening the drain valve 26 is shortened.

In order to perform the aforementioned method (1), for example, at least one of the following can be adopted: (a) pilot pressure put into the decompression valve 23 and secondary pressure of the decompression valve 23 (gas pressure passing in the air-and-water separator 25) are increased while shortening the valve-opening time of the injector 23e shorter than that of the ordinary state process or the valve is normally closed; and (b) the valve-opening time of the drain valve 26 is extended longer than that of the ordinary state process.

In this case, it is preferable that the gas pressure passing through the air-and-water separator 25 should be higher and the valve-opening time of the drain valve 26 should be longer if a greater amount of water is stored in the air-and-water separator 25. The air-and-water separator 25 having such a configuration enables rapid water-draining of the water therefrom.

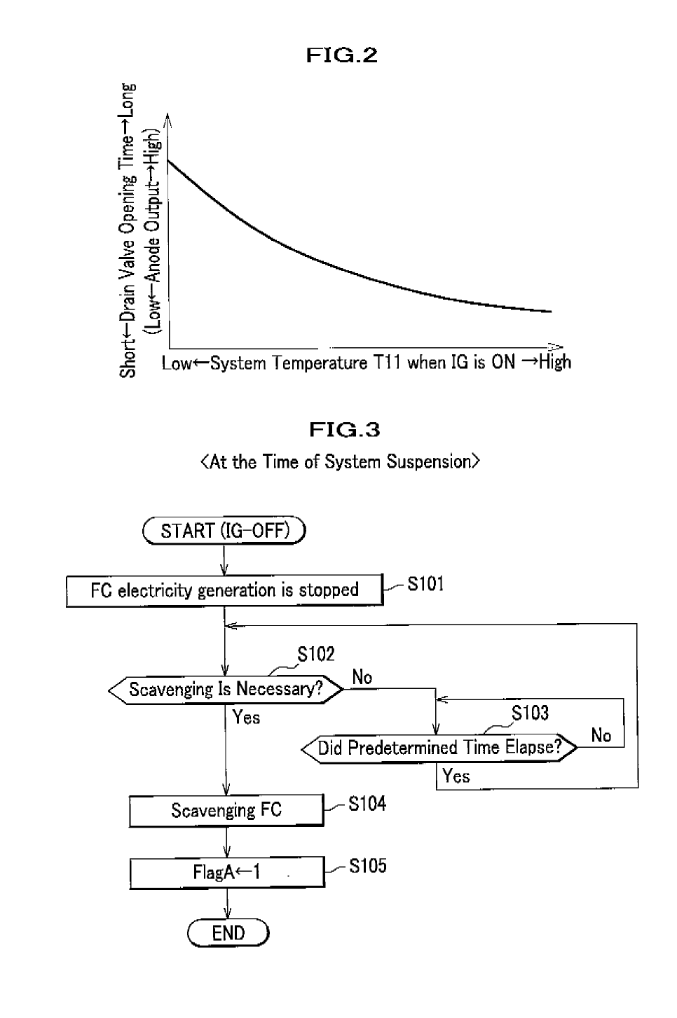

It should be noted that the pressure may be increased and the valve-opening time may be extended by fixed values determined based on preliminarily-conducted tests or the likes. Alternatively, the valve-opening time of the drain valve 26 may be extended based on the decreasing system temperature T11 and based on the system temperature T11 with reference to the map shown in FIG. 2 when the IG61 is turned on (when the system is started up) to increase the gas pressure (anode pressure) passing in the air-and-water separator 25.

This is because, a greater amount of water is presumed to condense while the system is stop if the system temperature T11 is low, and accordingly, the amount of water which is presumed to be frozen in the drain-function unit is more significant, and then, the amount of water to be drained immediately after being thawed is also presumed to be more significant.

Further alternatively, the pressure may be increased and the time for opening the valve may be extended based on the facts that a greater amount of water is stored in the air-and-water separator 25 if time necessary for determining that the drain-function unit is thawed is longer and if a total electricity value of the fuel cell stack 10 is greater. Further alternatively, the ECU 70 controls so that the pressure may be increased and the time for opening the valve may be extended based on the water level of the water stored in the air-and-water separator 25 by using a water level sensor provided in the air-and-water separator 25.

For performing the aforementioned method (2), a post-thawing valve-opening interval in which the valve-opening interval is shortened may be used in place of the valve-opening interval for the drain valve 26 set for the ordinary state process.

Similarly, in this case as shown in FIG. 2, the post-thawing valve-opening interval may be shortened since a greater amount of water is stored in the air-and-water separator 25 if the temperature of the system temperature T11 is lower at the time of starting up the system.

### <ECU: Water-Draining-Determining Function>

The ECU 70 (water-draining-determining unit) is provided with a function of determining whether or not a predetermined amount of water is drained so that the air-and-water separator 25 can perform an ordinary water-draining control if the drain-function unit is thawed and the post-thawing water-draining is performed. If the ECU 70 (drain-control unit) decides that the predetermined amount of water is drained, the ECU 70 (drain-control unit) changes the process to the ordinary-water-draining control.

It should be noted that, in this case, the amount of water drained from the air-and-water separator 25 is calculated based on, for example, the product of the accumulated valve-opening time of the drain valve 26 and the pressure in the air-and-water separator 25 sent from the pressure sensor 29A. Alternatively, a water level sensor may be provided in the air-and-water separator 25 for determining that a predetermined amount of water is drained if the water level of the air-and-water separator 25 reaches the predetermined water level.

Although the predetermined amount as a reference for determination may be a fixed value determined based on preliminarily-conducted tests, for example, in a fuel cell system similar to that shown in FIG. 2, the predetermined amount may be compensated to increase if the ECU 70 presumes that the system temperature T11 at the time of starting-up the system is lower and that a greater amount of water should be drained after thawing.

### <<Operation of Fuel Cell System>>

Operations of the fuel cell system 1 will be explained next.

### <At the Time of Stopping the System>

Firstly, the fuel cell system 1 in a stopped state will be explained with reference to FIG. 3.

It should be noted that, when the IG61 is turned off, the ECU 70 receives an OFF-signal and starts operations shown in FIG. 3. A flag A, which will be explained later, is 0 (zero) in an initial state.

In step S101, the ECU 70 stops generation of electricity in the fuel cell stack 10.

More specifically, a contactor (not shown in the drawings) provided between the fuel cell stack 10 and the output detector 53 is turned off for shutting off an external circuit including the fuel cell stack 10 and the driving motor 51 electrically. In addition, the ECU 70 closes the shut-off valve 22 for causing the hydrogen tank 21 to stop the supply of hydrogen.

In step S102, the ECU 70 decides whether or not the ECU 70 must scavenge the fuel cell stack 10.

More specifically, the ECU 70 decides whether or not the currently-obtained system temperature T11 (temperature of the fuel cell stack 10) sent from the temperature sensor 29B is lower than predetermined temperature T1. The predetermined temperature T1 means that the inside of the fuel cell stack 10 may be frozen later unless otherwise treated. The predetermined temperature T1 is obtained based on preliminarily-conducted tests and is stored in the ECU 70 in advance.

If the ECU 70 decides that the system temperature T11 is lower than the predetermined temperature T1 and that the fuel cell stack 10 must be scavenged (S102·Yes), the process in the ECU 70 proceeds to step S104. On the other hand, if the ECU 70 decides that the system temperature T11 is not lower than the predetermined temperature T1 and that the fuel cell stack 10 does not have to be scavenged (S102·No), the process in the ECU 70 proceeds to step S103.

In the step S103, the ECU 70 decides whether or not predetermined time Δt1 (for example, 30 minutes to 1 hour) has lapsed after determination in the step S102,

If the ECU 70 decides that the predetermined time Δt1 has lapsed (S103·Yes), the process in the ECU 70 proceeds to the step S102. Accordingly, the fuel cell stack 10 is prevented from being frozen since the determining process of the step S102 is performed every predetermined time Δt1 (S103·Yes) even if the temperature is not low (S102·No) immediately after stopping generation of electricity.

On the other hand, if the ECU 70 decides that the predetermined time Δt1 has not lapsed (S103·No), the ECU 70 repeats the determining process of the step S103.

In the step S104, the ECU 70 scavenges the fuel cell stack 10.

More specifically, the ECU 70 operates the compressor 31, opens the scavenging-gas-introducing valve 41, the scavenging-gas-discharging valve 28, and the back-pressure-regulating valve 33, introduces the scavenging gas sent from the compressor 31 into the anode flow path 12 and the cathode flow path 13, removes gas (hydrogen, air, or the like) and water from the anode flow path 12 and the cathode flow path 13, and scavenges the fuel cell stack 10. Such scavenging for the fuel cell stack 10 is performed for a predetermined time determined based on, for example, preliminarily-conducted tests.

However, the method for scavenging the fuel cell stack 10 is not limited to a method of scavenging the anode flow path 12 and the cathode flow path 13 in parallel, and a method of scavenging, for example, the cathode flow path 13 and the anode flow path 12 in this order may be adoptable.

In step S105, the ECU 70 sets the flag A to 1 (one), which corresponds to whether or not air-purge is performed in the fuel cell stack 10, and thereby memorizes a fact that the fuel cell stack 10 has been scavenged.

Afterwards, the process of ECU 70 proceeds to END and finishes the process at the time of stopping the system.

### <At the Time of Starting-Up the System>

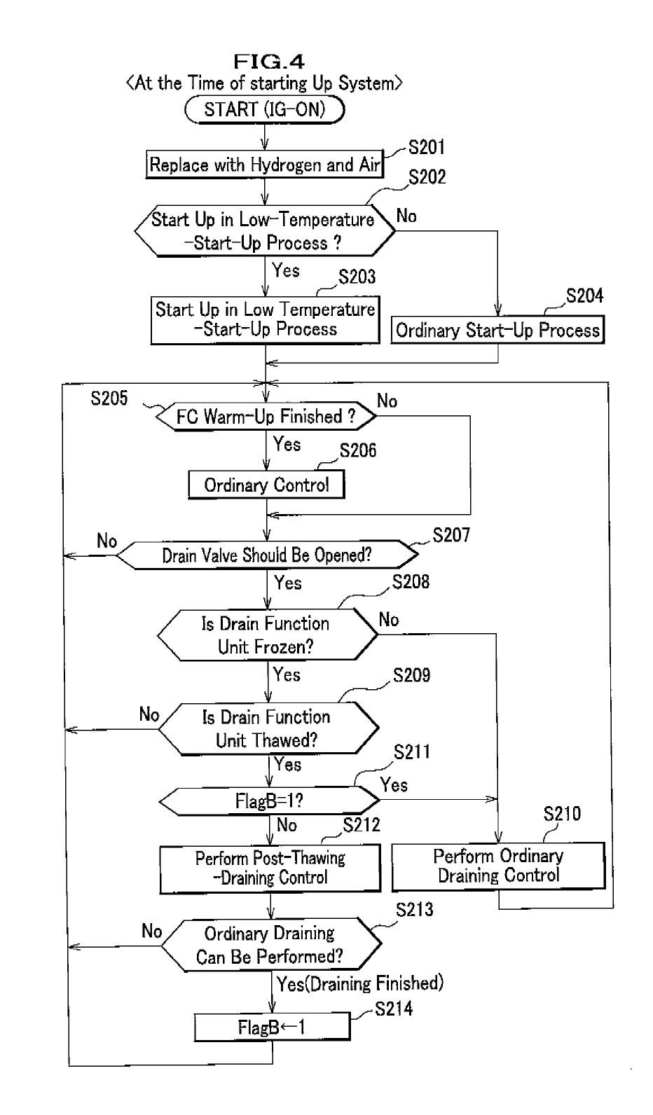

The fuel cell system 1 in a start-up state will be explained next with reference to FIG. 4.

It should be noted that, when the IG61 is turned on, the ECU 70 receives an ON-signal and starts operations shown in FIG. 4. Also, in this exemplified case, the ECU 70 increases water-draining quantity per one time of opening the drain valve 26 if the drain-function unit, which has been presumed to be frozen, is thawed. In addition, a flag B, which will be explained later, is 0 (zero) in an initial state.

In step S201, the ECU 70 replaces the inside of the anode flow path 12 with hydrogen and replaces the inside of the cathode flow path 13 with air, respectively.

More specifically, the ECU 70 opens the shut-off valve 22 and opens the purge valve 27 periodically, and pushes hydrogen into the anode flow path 12. In parallel, the ECU 70 operates the compressor 31 to push air into the cathode flow path 13. Such replacements into hydrogen and air are maintained until, for example, the OCV of the single cell 11 exceeds a predetermined OCV and the fuel cell stack 10 is operable.

In step S202, the ECU 70 decides whether or not the fuel cell system 1 is started up in low-temperature-startup process. Here, the low-temperature-startup process is a method to warm-up rapidly the fuel cell stack and start up the fuel cell stack 10. More specifically, for example, the ECU 70 decides that the fuel cell stack 10 should be started up rapidly in low-temperature-startup process if the system temperature T11 when the IG61 is turned on is lower than the predetermined temperature (for example, 0° C.) which indicates low-temperature-startup process, or if the flag A indicates 1 and the fuel cell stack 10 is scavenged when the system is stopped.

If the ECU 70 decides that the fuel cell system 1 needs the low-temperature-startup process (S202·Yes), the process in the ECU 70 proceeds to step S203. On the other hand, if the ECU 70 decides that the fuel cell system 1 does not need the low-temperature-startup process (S202·No), the process in the ECU 70 proceeds to step S204.

In the step S203, the ECU 70 causes the fuel cell stack 10 to start generating electricity while starting up the fuel cell system 1 in the low-temperature-startup process.

More specifically, in order to increase heat generated by self-heating due to electricity generated and to warm up the fuel cell stack 10 rapidly, for example, the ECU 70 supplies hydrogen and air both in more significant flow amount and pressure than those in an ordinary startup process in the step S204, and controls the VCU 52 for increasing the electric current taken out from the fuel cell stack 10. It should be noted that excess electric current of the fuel cell stack 10 is charged into, for example, the battery 54.

Afterwards, the process in the ECU 70 proceeds to step S205.

In the step S204, the ECU 70 causes the fuel cell stack 10 to start generation of electricity while starting up the fuel cell system 1 in the ordinary startup process.

Afterwards, the process in the ECU 70 proceeds to the step S205.

In the step S205, the ECU 70 decides whether or not the fuel cell stack 10 finishes the warming-up. For example, the ECU 70 decides that the warming-up is finished if the system temperature T11 is at warming-up-finishing temperature or higher determined based on preliminarily-conducted tests or if a predetermined time has lapsed after starting generation of electricity.

If the ECU 70 decides that the warming-up of the fuel cell stack 10 is finished (S205·Yes), the process in the ECU 70 proceeds to step S206. On the other hand, if the ECU 70 decides that the warming-up of the fuel cell stack 10 is not finished (S205·No), the process in the ECU 70 proceeds to step S207.

In the step S206, the ECU 70 controls the fuel cell system 1 in accordance with the ordinary state process. The control in the ordinary state process means that electricity is generated in the fuel cell stack 10 while supplying hydrogen and air commensurate with the amount of electricity to be generated which is requested by an accelerator (not shown in drawings) or the like.

It should be noted that, the process changes from the low-temperature start-up process or the ordinary start-up process to the ordinary control in the step S206 when the determination in the step S205 results in “Yes” for the first time.

Afterwards, the process in the ECU 70 proceeds to the step S207.

In the step S207, the ECU 70 decides whether or not the drain valve 26 should be opened. It should be noted that, as previously explained, the determination that the drain valve 26 should be opened is made at the predetermined reference interval.

If the ECU 70 decides that the drain valve 26 should be opened (S207·Yes), the process in the ECU 70 proceeds to step S206. On the other hand, if the ECU 70 decides that the drain valve 26 should be not opened (S207·No), the process in the ECU 70 proceeds to the step S205.

In the step S208, the ECU 70 presumes whether or not the drain-function unit (drain valve 26, pipings 26a and 26b, or the like) is frozen. More specifically, the ECU 70 presumes that the drain-function unit is frozen at present if the drain-function unit has experienced a frozen state between a previous system suspension and a currently-started-up condition of the system. For example, as previously explained, the ECU 70 presumes that the drain-function unit has experienced a frozen state if the fuel cell stack 10 is scavenged with reference to the flag A while the system is stopped.

If the ECU 70 presumes that the drain-function unit is frozen (S208·Yes), the process in the ECU 70 proceeds to step S209. On the other hand, if the ECU 70 presumes that the drain-function unit is not frozen (S208·No), the process in the ECU 70 proceeds to step S210.

In the step S210, the ECU 70 performs the ordinary water-draining control.

More specifically, the ECU 70 opens the drain valve 26 for ordinary valve-opening time. Accordingly, the water stored in the air-and-water separator 25 is drained into the diluting unit 34 through the piping 26a, the drain valve 26, and the piping 26b.

Afterwards, the process in the ECU 70 proceeds to the step S205.

In the step S209, the ECU 70 decides whether or not the drain-function unit has already been thawed. The ECU 70 decides that the drain-function unit has already been thawed, for example, if the currently-obtained system temperature T11 is at the thawing temperature T4 or higher.

If the ECU 70 decides that the drain-function unit has already been thawed (S209·Yes), the process in the ECU 70 proceeds to step S211. On the other hand, if the ECU 70 decides that the drain-function unit has not been thawed (S209·No), the process in the ECU 70 proceeds to the step S205.

In the step S211, the ECU 70 decides whether or not the flag B, which indicates a status of the water-draining having been finished after the drain-function unit is thawed, is 1 (one).

If the ECU 70 decides that the flag B is set to 1 (one) and that the water-draining is finished (S211·Yes), the process in the ECU 70 proceeds to the step S210. On the other hand, if the ECU 70 decides that the flag B is not set to 1 (one) (the flag B indicates 0 (zero)) and that the water-draining has not been finished (S211·No), the process in the ECU 70 proceeds to step S212.

In the step S212, the ECU 70 performs water-draining after the drain-function unit is thawed. More specifically, in order to drain, after thawing, a significant amount of the water which is presumed to be stored in the air-and-water separator 25 rapidly, the ECU 70 extends the valve-opening time for the drain valve 26 than that of the ordinary water-draining control (S210) or controls the injector 23e to increase the gas pressure passing in the air-and-water separator 25 for opening the drain valve 26.

In step S213, the ECU 70 decides whether or not the ordinary water-draining can be performed, namely, whether or not the water in the air-and-water separator 25 can be drained by performing a post-thawing water-draining control (S212) so that the process changes to the ordinary water-draining control (S210).

If the ECU 70 decides that the ordinary water-draining can be performed (S213·Yes), the process in the ECU 70 proceeds to step S214. On the other hand, if the ECU 70 decides that the ordinary water-draining cannot be performed (S213·No), the process in the ECU 70 proceeds to the step S205.

In the step S214, the ECU 70 sets the flag B to 1 (one) and memorizes a fact that the ordinary water-draining control can be performed.

Afterwards, the process in the ECU 70 proceeds to the step S205, and then, determination in a subsequent time in the step S211 will be “Yes”, so the process proceeds to the ordinary water-draining control (S210).

### <<Effect of Fuel Cell System>>

The aforementioned fuel cell system 1 achieves the following effects.

If the ECU 70 presumes that the drain-function unit is frozen (S208·Yes), and when the drain-function unit has not been thawed (S209·No), the ECU 70 will not perform the post-thawing water-draining (S212) or the ordinary water-draining (S210). That is, since the ECU 70 does not control to open the drain valve 26, the drain valve 26 in the frozen state is never opened; therefore, defect based on an inadvertent opening of the frozen drain valve 26 can be prevented.

If the ECU 70 decides that the drain-function unit, which has been presumed to be frozen (S208·Yes), is thawed (S209·Yes), the water stored in the air-and-water separator 25 can be drained rapidly since the valve-opening time for the drain valve 26 is extended or since the gas pressure is increased and post-thawing water-draining for increasing the amount of the water is performed (S212). Accordingly, the water in the air-and-water separator 25 is hardly supplied to the anode flow path 12 through the piping 25b or the like; therefore, excess water is prevented from lowering the power-generating capability of the fuel cell stack 10.

In addition, the drain valve 26 will not be opened purposelessly since the process transfers to the ordinary water-draining immediately (S211·Yes, S210) when the ECU 70 decides that a predetermined amount of the water is drained after thawing and that the ordinary water-draining can be performed (S213·Yes). Accordingly, the electricity consumption of the electromagnetic drain valve 26 is reduced while obtaining the remaining power, and the hydrogen, which should be circulated, can be prevented from being discharged to the exterior of a vehicle through the drain valve 26 or the like.

The present invention is not limited to the aforementioned embodiment and may be modified, for example, as follows within the range or purpose of the present invention.

In the fuel cell system in the aforementioned embodiment, the pressure in the anode is increased or the post-thawing water-draining (S212) is performed for extending the valve-opening time to increase the amount of the water drained in one time of opening of the drain valve 26 when the ECU 70 decides that the drain-function unit which has been presumed to be frozen (S208·Yes) is thawed (S209·Yes).

Alternatively, the ECU 70 may increase the time of Yes counted in the step S207 by shortening the interval between opening states of the drain valve 26 (i.e. valve-closing time), namely, by using the post-thawing valve-opening interval, in which the valve-opening interval (determination made by the ECU 70 that the drain valve 26 should be opened) is shortened, in order to increase the amount of the water drained from the air-and-water separator 25 when the drain-function unit is thawed.

Although the aforementioned embodiment has exemplarily shown a case in which the present invention is applied to a fuel cell system 1 mounted on a fuel-cell vehicle, the present invention may be alternatively applied to a fuel cell system mounted on a motorcycle, a train, or a vessel; a home-or-business-use stationary fuel cell system; or a built-in hot-water-supply fuel cell system.

What is claimed is:

1. A fuel cell system comprising:
a fuel cell for generating electricity, the fuel cell having a fuel gas flow path and an oxidizer-gas flow path, the fuel gas being supplied to the fuel gas flow path, oxidizer gas being supplied to the oxidizer-gas flow path;
a fuel-gas-circulating line for circulating the fuel gas by returning fuel-off-gas discharged from the fuel gas flow path to a fuel gas flow path upstream relative to the fuel cell;
an air-and-water separator provided in the fuel-gas-circulating line, the air-and-water separator separating water from the fuel-off-gas and storing the separated water;
a drain unit for draining the separated water stored in the air-and-water separator, the drain unit including a drain valve through which the water is drained;
a drain-control unit for controlling the drain unit;
a determining unit for determining whether or not the drain-control unit decides that the drain unit should be opened;
a frozen-state-presuming unit for presuming whether or not the drain unit is frozen if the determining unit determines that drain-control unit decides that the drain unit should be opened; and
a thawing-state-determining unit for determining whether or not the drain unit is thawed if the frozen-state-presuming unit presumes that the drain unit is frozen,
wherein the drain-control unit controls the drain unit in such a manner that a greater amount of the water is drained than a water drained in an ordinary state process which presumes that the drain unit is not frozen, if the thawing-state-determining unit determines that the drain unit is thawed after the frozen-state-presuming unit presumes that the drain unit is frozen.

2. The fuel cell system as claimed in claim 1, further comprising a gas-pressure control apparatus controlling pressure of the fuel-off-gas flowing through the air-and-water separator in such a manner that the pressure of the gas flowing through the air-and-water separator is higher than pressure of the gas in the ordinary state process if the thawing-state-determining unit determines that the drain unit is thawed after the frozen-slate-presuming unit presumes that the drain unit is frozen.

3. The fuel cell system as claimed in claim 2, wherein the gas-pressure control apparatus controls in such a manner that the greater the amount of water stored in the air-and-water separator is, the higher the pressure of the fuel-off-gas flowing through the air-and-water separator is.

4. The fuel cell system as claimed in one of claims 1 to 3, wherein the drain-control unit extends time for opening the drain valve longer than time for opening the drain valve in the ordinary state process if the thawing-state-determining unit determines that the drain unit is thawed after the frozen-state-presuming unit presumes that the drain unit is frozen.

5. The fuel cell system as claimed in claim 4, wherein the drain-control unit controls the drain valve in such a manner that the greater the amount of water stored in the air-and-water separator is, the longer a time for opening the drain valve is.

6. The fuel cell system as claimed in claim 1, wherein the drain-control unit does not open the drain valve if the frozen-slate-presuming unit presumes that the drain unit is frozen and the thawing-state-determining unit determines that the drain unit is not thawed.

7. The fuel cell system as claimed in claim 1, wherein the drain-control unit controls the drain unit in the ordinary state process if the frozen-state-presuming unit presumes that the drain unit is frozen; if the thawing-state-determining unit determines that the drain unit is thawed; and if a predetermined amount of water sent from the air-and-water separator is drained by the drain unit.
